(19) United States
(12) Patent Application Publication
(10) Pub. No.: US 2015/0277754 A1
(43) Pub. Date: Oct. 1, 2015

(54) SYSTEM AND METHOD FOR CONTROLLING MASSAGE OPERATIONS OF A MOTOR VEHICLE SEAT

(71) Applicant: FORD GLOBAL TECHNOLOGIES, LLC, Dearborn, MI (US)

(72) Inventors: Philipp MISCH, Aachen NRW (DE); Jeroen LEM, Maastricht (NL); Stefan WOLTER, Wuerselen NRW (DE); Florian GOLM, Herzogenrath (DE); Johnathan Andrew LINE, Northville, MI (US)

(21) Appl. No.: 14/667,105

(22) Filed: Mar. 24, 2015

(30) Foreign Application Priority Data
Mar. 26, 2014 (DE) 10 2014 205 574.1

(51) Int. Cl. G06F 3/0488; G06F 3/0486; B60N 2/44; G06F 3/0484

(52) U.S. Cl. CPC G06F 3/04886; G06F 3/04847; G06F 3/0486; G06F 3/04842; B60N 2/448

(57) ABSTRACT

A system and method for controlling and selecting massage operations of a motor vehicle seat having a plurality of inflatable cushions and a control system controlling inflation of the cushions to perform a massage function. A touch-screen display is used to make inputs to the control system. The display is calibrated as a two-dimensional coordinate system on which are displayed pictograms representing a plurality of massage function blocks. To create or generate a massage program to be performed by the controller/seat, an operator drags-and-drops the pictograms on the display to respective positions in the coordinate system, thereby adjusting respective settings of two parameters of the massage function, the coordinate of the pictograms in each coordinate axis corresponding to one of the respective parameters.

### CROSS-REFERENCE TO RELATED APPLICATIONS

This application claims foreign priority benefits under 35 U.S.C. §119(a)-(d) to DE 10 2014 205 574.1 filed Mar. 26, 2014, which is hereby incorporated by reference in its entirety

### TECHNICAL FIELD

The invention relates to a system for controlling massage operations of a motor vehicle seat by means of a two-dimensional display which allows adjustment of settings of parameters of one or more massage functions performed by the seat.

### BACKGROUND

It is generally known to equip seats of motor vehicles with a system operable to perform massage operations, for example for the lumbar support and the actual sitting surface.

However, the simple and intuitive handling of the control is problematic for the operators, especially since this should be possible for the driver while driving.

A compromise has to be made here between the variety of the control and the degree of detail as well as the simplicity and the predefined patterns.

DE 10 2004 037 069 A1, US 2014/025258 A1, and EP 1 839 932 B1 disclose control systems with which the operations of a corresponding massage system can be set and controlled in a very detailed way.

Although such systems permit a largely user-specific setting of the massage operations, they are however complicated and awkward to operate, with the result that the driver has to divert his attention from the steering of the vehicle in an undesired way. In particular, in this context the driver must run through a plurality of menu hierarchies in order to make a setting.

### SUMMARY

In a first aspect of the disclosure, a display for controlling massage operations of a motor vehicle seat comprises a two-dimensional coordinate system displaying a pictogram which represents a massage function. The pictogram is movable by an operator to a position in the coordinate system in order to adjust settings of two parameters of the massage function. The coordinate of the pictogram in each of the two axes of the coordinate system corresponds to one of the respective parameters being set.

The display may be further operative to display a second pictogram representing a second massage function, and positioning of the second pictogram together with the first pictogram on the display creates a massage program comprising both the first and second massage functions sequentially. The relative location of the first and second pictograms in one of the coordinate system axes selects the sequence in which the two massage functions occur in the massage program.

In a further aspect of the disclosure, a method of controlling massage operations of a motor vehicle seat comprises providing a touch-screen display calibrated such that first and second axes of a two-dimensional coordinate system represent respective settings of two parameters of a massage function, and touching the display to move a pictogram representing the massage function to a position on the display to thereby select settings of the two parameters.

The method may further comprise touching the display to move a second pictogram representing a second massage function to a second position on the display to thereby select settings of two parameters of the second massage function. The massage function and the second massage function are thereby combined to form a massage program to be performed by the seat.

In a further aspect of the disclosure, apparatus comprises a seat having at least one inflatable cushion, a control system controlling inflation of the cushion(s) to perform a massage function, and a display for making inputs to the control system. The display has a two-dimensional coordinate system on which is displayed a pictogram representing the massage function, and the pictogram is movable by an operator to a position in the coordinate system to adjust respective settings of two parameters of the massage function, the coordinate of the pictogram in each coordinate axis of the coordinate system corresponding to the respective parameter.

As is disclosed herein, the selection method and intuitive operator control can be simplified to a high degree if the massage functions which are organized in blocks are displayed on the display in a two-dimensional fashion in a coordinate system and their position with respect to the coordinate axes can be changed by the operator, and their position in terms of the respective coordinate axis corresponds to a parameter variable of the respective massage function. In other words, the position of the respective massage function block on the display corresponds to two settings of parameters of the respective massage function. The parameters are therefore assigned to the respective coordinate axes.

A desired massage program comprising a sequential combination of massage functions can therefore be created in a simple way by combining, adding or deleting massage functions which are represented by pictograms and organized in blocks, each of which per massage zone. By means of the positions (coordinates) of the pictograms on the display, two parameters of a massage function are set or defined at the same time.

The position of the massage function pictogram in terms of the respective coordinate axis corresponds to at least one adjustable parameter of a massage function. Parameters may include at least massage intensity, massage speed, massage pattern, massage duration, massage profile, and massage sequence.

In one preferred embodiment, the display is a touch-screen of the general type well-known in the art and the pictograms representing the massage functions are positioned by the operator with a finger or other appropriate pointer implement, such as a stylus or a pen.

If the display displays the massage function pictograms in a polar coordinate system, a particularly compact display means can be obtained.

In a polar coordinate system, the distance from the pole (the rectangular coordinate) may correspond to one variable parameter of a massage function. In other words, one parameter may be set in the manner of the concentric circles around the pole, and the other parameter may be set by means of the angular position/coordinate of the function pictograms with respect to one another. Accordingly, the angular position of a first massage function to a second massage function can correspond to the massage sequence on the display when viewed in the clockwise direction.

The position of the massage function blocks with respect to one another will therefore usually determine the sequence of the massage.

It is also possible to edit the respective massage block by means of an operator selection. This can be done in a simple way by selecting predefined parameters (for example massage intensity, massage pattern, massage duration, and massage profile). Massage pattern is understood to mean the different actuation of the massage actuators, for example air cushions, over time, in order to create a pattern (for example a wave). Massage profiles are understood to mean the direction of the time sequence of the actuation of the massage actuators/cushions, for example from bottom-to-top, from left-to-right, etc.

In principle, any possible parameter setting of a massage system can be selected with the disclosed system.

By means of the invention it is therefore possible for the user to create or generate a massage program comprising two or more massage functions (represented by pictograms and organized in sequential blocks) combined in a desired consecutive sequence, and at the same time define a further parameter of the functions by positioning the respective in the other spatial direction (coordinate axis). The steps and, in particular, menu hierarchies which are necessary to create a multi-segment massage are therefore reduced.

Further features and details of the invention can be found in the following description of the drawing, in which:

### BRIEF DESCRIPTION OF THE DRAWINGS

FIG. 1 shows a perspective and schematic view of a motor vehicle seat, and

FIG. 2 shows a schematic view of a display for controlling the massage operations of the seat from FIG. 1;

FIG. 3 shows a schematic view of an alternative display for controlling the massage operations of the seat from FIG. 1;

FIG. 4 shows a schematic view of an alternative display for controlling the massage operations of the seat from FIG. 1; and

FIG. 5 shows a schematic block circuit diagram of the control system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

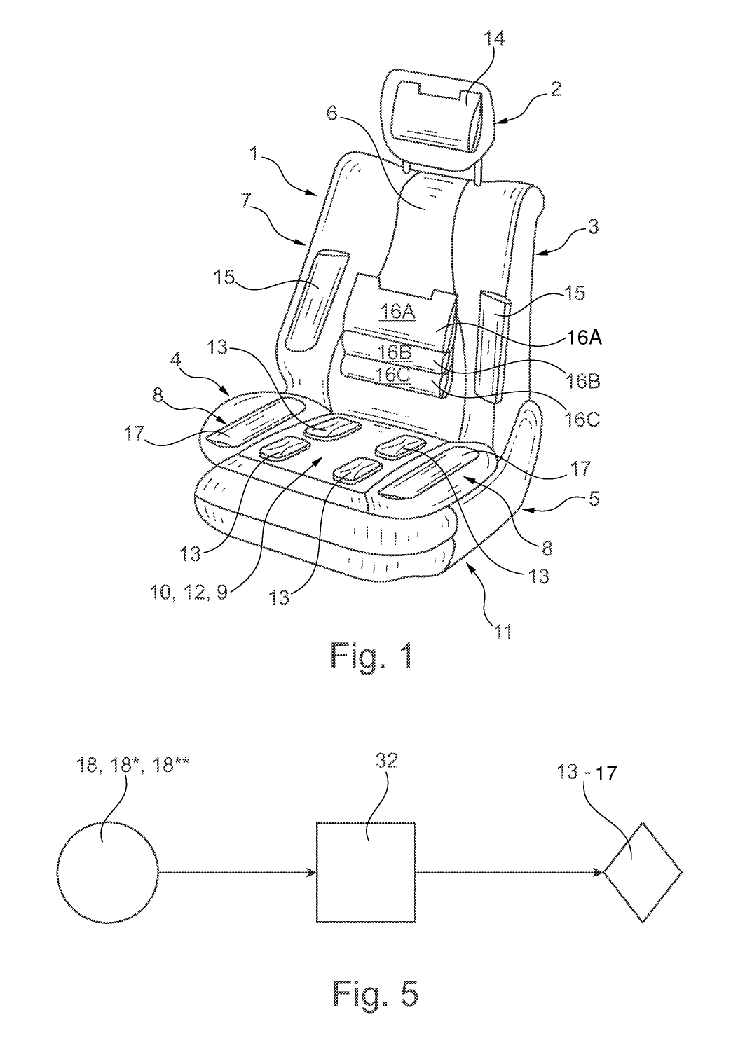

FIG. 1 shows a schematic view of a known seat, denoted in its entirety by 1, in an oblique perspective for the sake of illustration, wherein the transparency permits a view into the interior of the seat. The seat 1 comprises a headrest 2, which is fitted onto the top of a backrest 3, which in turn is coupled to the seat 4 bottom via an adjustable hinge 5. The seat 1 is supported here by a frame 11 made of sheet steel, which frame 11 is arranged under the actual sitting surface and is connected to the vehicle.

The backrest 3 has an anatomically shaped support 6, for example in an S shape in the longitudinal section, for the back of the vehicle occupant, which support 6 is bounded at the sides by protruding ribs 7 which provide the vehicle occupant with lateral support.

The seat bottom 4 also has a support 9 which defines the actual sitting surface. Ribs 8, which provide the occupant with lateral support, in particular in bends, are also provided on the sides here.

The support 9 is formed by a foam block 10 composed of a suitable natural material and/or plastic which is covered, if appropriate, with a suitable material such as leather. The support preferably has the customary and known properties such as resilience, shock absorption, transportation of moisture etc. In addition, it is possible to provide heating and/or cooling devices in the support.

A support plate 12 made of rigid material is provided underneath the foam block 10. The support plate 12 is arranged here under the rear region of the sitting surface, where the vehicle occupant's posterior usually rests.

Four inflatable air cushions 13 are located in the seat bottom, between support plate 12 and frame 11. The air cushions 13 are arranged here in such a way that they rest under the corners of the approximately rectangular sitting surface. A control system (indicted schematically in FIG. 5) includes electronic control module(s), valves, compressor, and related components to enable control of inflation and deflation of the air cushions 13 to permit the shock absorption of the seat to be set and improved even during travel, by means of the applied air pressure. The control system can automatically adjust the air pressure in the air cushions 13 after evaluation of data, originating from sensors, about the driving situation and the vehicle occupant. Manual adjustment, predefinition or intervention into the automatic control is also possible.

The seat 1 also has, in the ribs 7 and 8, the support 6 and the headrest 2, further air cushions 15, 17, 16A-C and 14, which serve to massage and adapt contours. Said air cushions 15, 17, 16A-C, and 14 can also be adjusted and/or operated via the control system (already mentioned). In addition, said air cushions 15, 17, 16A-C and 14 can be inflated in the event of an impact of the vehicle and serve as additional impact protection in order to prevent contact between the vehicle occupant and the metal frame 11 of the seat.

A seat having a controller, sensors, and inflatable cushions of the type described herein is taught in U.S. Pat. No. 8,678,500 B2, the disclosure of which is incorporated herein by reference.

The four air cushions 13, the inflation/deflation of which can be controlled and can be acted on independently of one another, beneath the support plate 12 permit not only vertical positioning but also tilting of the support plate 12 about two axes which run parallel to the plane of the sitting surface and perpendicular to one another. As a result, tilting of the pelvis in the direction of front to rear and vice versa can be generated, said tilting having a relieving effect and preferably being used, for example, for spinal column manipulation or therapy. The avoidance of back pain depends particularly on this tilting of the pelvis. This movement can be coupled with a tilting movement from left to right, with the result that the alternating cyclical tensioning and relaxing of the muscles, owing to the movement of the pelvis, allows fatigue to be particularly well avoided.

It is therefore clear that different massage patterns, intensities and durations are possible by virtue of the programmed, sequential actuation of the air cushions and zones.

The above described seat and controller are therefore able to carry out different massage functions which are performed by different zones of the seat (lumber region to massage the back, or seat bottom to massage the posterior and/or tilt the pelvis, for example).

For the purpose of illustration, the system for controlling and selecting will be explained below on the basis of only two massage functions, corresponding to the lumbar massage and the tilting of the pelvis. Of course, any number of massage functions can be used within the scope of the method.

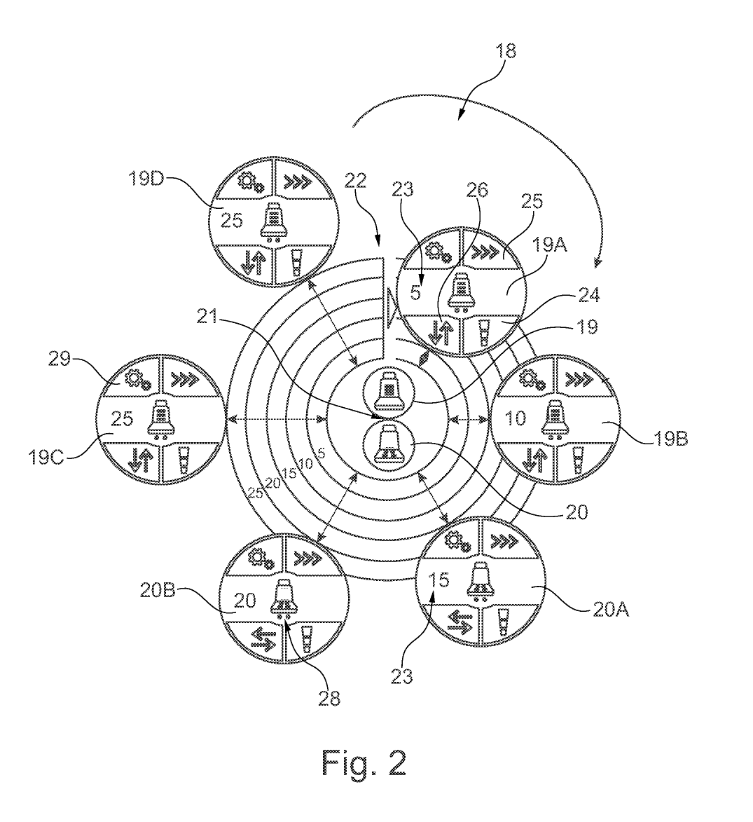

The above-described selection of the respective air cushions for the adjustment thereof and their adjustment are carried out with the displays described below firstly in structural terms with respect to FIGS. 2 to 4, and secondly with reference to the control system according to FIG. 5.

FIG. 2 illustrates a touch-screen display 18, which permits the various massage functions (described above) to be selected and adjusted by touching one of the pictograms 19, 20, followed by “dragging-and-dropping” the pictogram for the desired massage function.

In the instant example, the massage functions represented by the two pictograms 19, 20 are for a lumbar massage function and a pelvis-tilting function, respectively. Pictogram 19 indicates the lumbar massage function using a symbol showing a seat with three bars in the seatback in the general location of the lumbar cushions 16A-C of FIG. 1. Pictogram 20 indicates the pelvis-tilting function using a symbol showing a seat with four spots on the seat bottom, in the general location of the cushions 13 of FIG. 1.

The operator can therefore visually identify the desired massage function by the symbol(s) of the pictograms, select (touch) the desired pictogram using a finger or implement (such as a pen or stylus), and move said pictogram to the desired position on the display by “dragging” it over the touch-screen 18, then removing the finger or implement from contact with the screen to “drop” the pictogram at the desired location. The pictograms 19, 20 remain visible inside the display center ring after being selected, dragged outward, and dropped, so that either of the pictograms may be selected multiple times. Thus, the selecting, dragging, and dropping of a pictogram outward from the center ring may be repeated so that two or more massage function pictograms are positioned around the circumference of the display and at various distances from the center, as shown in FIG. 2. This creates or generates a massage program comprising two or more (five, in the example shown in FIG. 2) “blocks” of massage functions that will be performed by the seat massage system in a consecutive temporal sequence, as described further below.

The massage function pictograms, each of which may be understood to represent a discrete block or phase of a massage program to be performed, are displayed by the touch-screen 18 in a polar coordinate system, wherein their position in terms of the respective coordinate axis corresponds to a variable and adjustable parameter of the respective massage function.

In the example illustrated, the display 18 is organized and calibrated so that the radial distance from the pole 21 (the radial coordinate in the polar coordinated system) is the duration of the respective massage function. In other words, the further away from the pole 21 a pictogram is arranged in the radially outward direction, the longer the setting of the duration of the selected massage function. In the instant case of FIG. 2, the duration can be set in increments of 5 seconds in the manner of the concentric circles, but the concentric circles may correspond to any appropriate time increment

The relative positions of the pictograms around the circumference of the display 18 (the polar coordinate) corresponds to the sequence in which the massage functions will be performed. In the instant case, the program sequence begins at the 12 o'clock position 22 on the display and progresses in the clockwise direction. Here, the seat 1 with the massage functions 19 and 20 would therefore perform a massage program composed of the following sequence of blocks or phases of functions: 19A, 19B, 20A, 20B, 19C, 19D.

After a pictogram is dragged-and-dropped at its desired location on the display 18, the pictogram graphically indicates the selected setting of one or more of the parameters. Here, the duration parameter of the function may be displayed by a corresponding number appearing in the pictogram in field 23: 5 seconds for pictogram/function 19A, 10 seconds for pictogram/function 19B, 15 seconds for pictogram/function 20A, etc.

The additional symbols contained in fields 24, 25, and 26 of each pictogram may indicate the settings of other parameters of the massage function, such as intensity, the speed and the pattern respectively. Field 28 indicates which seat has been selected: the left-hand item or “dot” (immediately below the seat icon) indicating the left/driver's seat; the right-hand item or “dot” indicating the right/passenger's seat.

After the respective pictogram 19A-D, 20A, B has been “dragged and dropped” at the desired location on the display 18, these symbols 25-28 are displayed in an enlarged form and the respective settings may be changed by touch control, such as by touching or “tapping” the symbol one or more times to sequence through a number of possible settings (such as low, medium, and high).

Further options can be selected and set by activating the field 29.

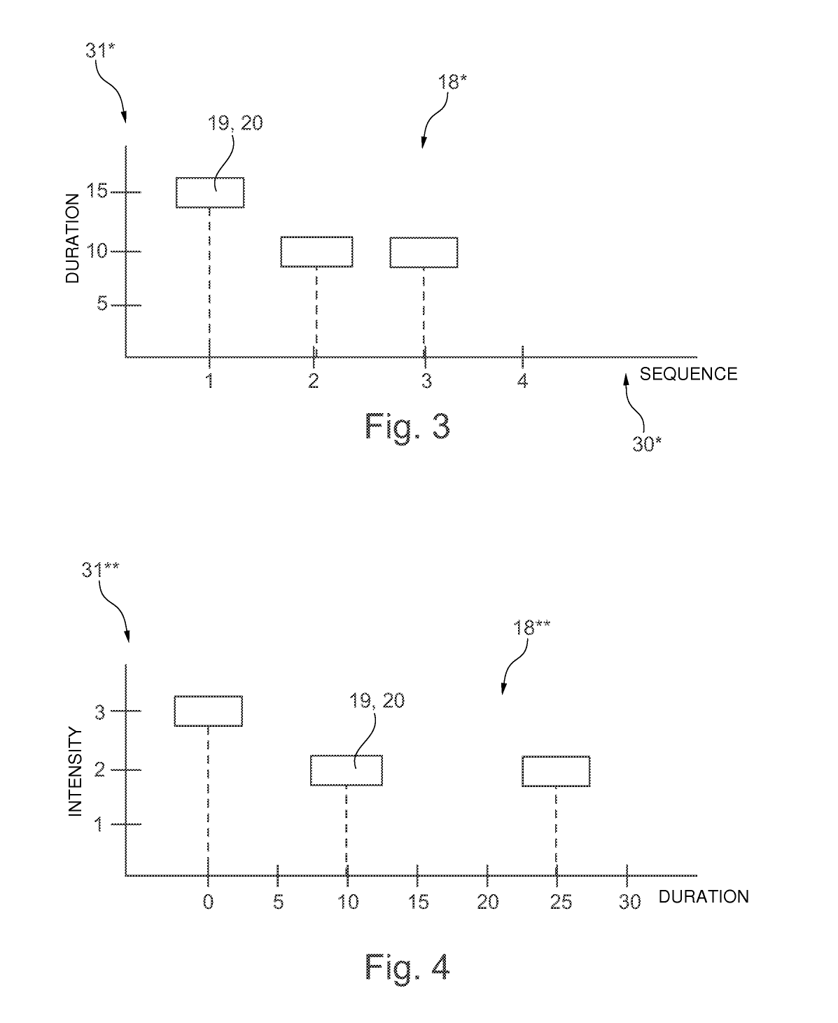

In FIGS. 3 and 4, variants 18*, 18** of the display are displayed.

The displays 18* and 18** differ essentially from the display 18 of FIG. 2 in having a different method of display using a Cartesian coordinate system, in which the relative sequence of the massage function blocks progresses linearly along the abscissa axis 30*, 30** and is apparent on the basis of the arrangement of the abscissa axis.

In FIG. 3, the position of the pictograms or blocks 19, 20 with respect to the ordinate axis 31* determines the duration of the respective massage function.

In contrast, in FIG. 4 the corresponding position with respect to the ordinate axis 31** determines the intensity of the respective massage function. In addition, in FIG. 4 the absolute position with respect to the abscissa axis 30** is used to set the duration of the massage functions.

FIG. 5 illustrates a schematic block diagram of the control system of the inflatable cushions 13-17 of the seat from FIG. 1 by means of one of the displays 18, 18*, 18**.

The respective display 18, 18*, 18** is electronically connected (for example by means of a CAN bus) to an electronic control system 32, with the result that the activations, selections, etc. from the display can be registered by the control system 32 and assigned to the function etc.

After the touch-screen 18, 18*, 18** has been activated the control system 32 subsequently performs the actuation of the cushions 13-17 for the desired function or setting of the seat 1.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A display for controlling massage operations of a motor vehicle seat, comprising a two-dimensional coordinate system displaying a pictogram representing a massage function, the pictogram movable to a position in the coordinate system by an operator to adjust settings of two parameters of the massage function, a coordinate of the pictogram in each axis of the coordinate system corresponding to the respective parameter setting.

2. The display of claim 1, wherein the display is further operative to display a second pictogram representing a second massage function, and positioning of the pictogram and the second pictogram on the display creates a massage program comprising the massage function and the second massage function.

3. The display of claim 2 wherein a location of the pictogram relative to the second pictogram in a first of the coordinate system axes selects a sequence of the two massage functions in the massage program.

4. The display of claim 3 wherein a second of the coordinate system axes corresponds to a massage intensity parameter.

5. The display of claim 1, wherein the pictogram is moveable by a drag-and-drop action by the operator.

6. The display of claim 1, wherein the coordinate system is a polar coordinate system.

7. The display of claim 1, wherein the display is a touch-screen and the pictogram is movable by the operator by touching the display with a finger and/or an implement.

8. The display of claim 1, wherein the pictogram comprises a symbol providing graphic indication of at least one of the parameters of the massage function.

9. The display of claim 8, wherein the pictogram further comprises a second symbol providing graphic indication of a third parameter of the massage function.

10. A method of controlling massage operations of a motor vehicle seat, comprising:
providing a touch-screen display calibrated such that first and second axes of a two-dimensional coordinate system represent respective settings of two parameters of a massage function; and
touching the display to move a pictogram representing the massage function to a position on the display to thereby select settings of the two parameters.

11. The method of claim 10 further comprising:
touching the display to move a second pictogram representing a second massage function to a second position on the display to thereby select settings of two parameters of the second massage function, and the massage function and the second massage function combine to massage program to be performed by the seat.

12. The method of claim 11 wherein relative locations in the first axis of the position and the second position establish a sequence of the massage function and the second massage function.

13. The method of claim 12 wherein the second axis corresponds to a massage intensity parameter.

14. The method of claim 10, wherein moving the pictogram is performed by a drag-and-drop action.

15. Apparatus comprising:
a seat having an inflatable cushion;
a control system controlling inflation of the cushion to perform a massage function; and
a display for making inputs to the control system and having a two-dimensional coordinate system on which is displayed a pictogram representing the massage function, the pictogram movable to a position in the coordinate system by an operator to adjust respective settings of two parameters of the massage function, the coordinate of the pictogram in each coordinate axis of the coordinate system corresponding to the respective parameter setting.

16. The apparatus of claim 15, wherein the display is further operative to display a second pictogram representing a second massage function, and positioning of the pictogram and the second pictogram on the display creates a massage program comprising the massage function and the second massage function.

17. The apparatus of claim 16 wherein relative locations in a first of the coordinate system axes of the pictogram to the second pictogram selects a sequence of the two massage functions in the massage program.

18. The apparatus of claim 17 wherein a second of the coordinate system axes corresponds to a massage intensity parameter.

19. The apparatus of claim 15, wherein the coordinate system is a polar coordinate system.

20. The apparatus of claim 15, wherein the display is a touch-screen and the pictogram is movable by the operator by touching the display with a finger and/or an implement.
